(19) United States
(12) Patent Application Publication
(10) Pub. No.: US 2021/0283628 A1
(43) Pub. Date: Sep. 16, 2021

(54) PORTABLE FLUID DISPENSER

(71) Applicant: ServLink Technology Resources Pte Ltd, Singapore City (SG)

(72) Inventor: Ian Chueen TAN, Singapore City (SG)

(21) Appl. No.: 17/279,562

(22) PCT Filed: May 8, 2019
(86) PCT No.: PCT/SG2019/050260

§ 371 Date: Mar. 24, 2021

(51) Int. Cl. B05B 9/08

(52) U.S. Cl. CPC B05B 9/0811

(57) ABSTRACT

The present invention is a handheld fluid dispenser that includes a container with a reservoir for storing fluid. The container has a lid which keeps it airtight. An air delivery conduit supplies air into an air chamber formed above the reservoir. An air outlet fluidly connects the air chamber to the exterior, whilst an end of a fluid outlet is submerged in the reservoir. In use, air is supplied to the air chamber thru the air delivery conduit, and by controlling the air flow thru the air outlet, a positively controllable air pressure in the air chamber courses the fluid in the reservoir to dispense out thru the fluid outlet.

### FIELD OF INVENTION

The present disclosure relates to a handheld fluid dispenser.

### BACKGROUND

The process of irrigation involves the transmission of a body of fluid from one point to another. In the context of patient care, irrigation is the delivery of a steady stream of fluid to an organ for example the mouth or a wound, so as to achieve hydration and the removal of deeper debris. This can be accomplished with a handheld fluid dispenser.

An exemplary fluid dispenser should process the following qualities. Firstly, it should be operable with one hand in order to allow an operator to manipulate the organ or wound with the other hand. Secondly, fluid flow control should be responsive to allow the operator to quickly commence and halt fluid delivery so as to ensure over-irrigation does not occur. Thirdly, the irrigator is able to handle different fluid with different viscosity. Fourthly the irrigator must be easy to wash and clean after use especially the fluid delivery passage that is exposed to the fluid. Fifthly, the irrigator must preferably be devoid of electrical components and circuits or if present, isolated from potential exposure to fluids while at the same time being affordable. Lastly, the irrigator must be affordable with minimum elaborate parts and components.

Accordingly, there exists a need for a portable fluid dispenser with the aforementioned qualities.

### SUMMARY OF THE INVENTION

A primary embodiment of the present invention is a handheld device for dispensing a fluid comprising a container having a reservoir of the fluid, with the container having a lid and an air chamber located above the reservoir, an air delivery conduit for supplying air into the air chamber and a fluid discharge outlet having an end that is immersed in the fluid wherein during a first state of operation, air in the air chamber is released thru the air outlet. Optionally, during a second state of operation, pressure in the air chamber pushes the fluid out through the discharge outlet. Optionally, the air outlet is connected to the air delivery conduit. Optionally, the air outlet is defined by a surface of the lid. Optionally, the handheld device further comprises an air pump operably attached to the air delivery conduit. Optionally, the air pump is located remotely. Optionally, the air pump is selected from a group comprising a positive displacement pump and an air compressor. Preferably, the positive displacement pump is selected from a group comprising a gear pump, screw pump, rotary vane pump, plunger pump, piston pump, progressing cavity pump and peristaltic pump. Most preferably, the positive displacement pump is a diaphragm pump.

### BRIEF DESCRIPTION OF DRAWINGS

FIG. 1 is a schematic representation of a fluid dispenser as known in the art.

FIG. 2 is a further schematic representation of a fluid dispenser as known in the art.

FIG. 3 is a schematic representation depicting a fluid dispenser according to a preferred embodiment.

FIG. 4 is a schematic representation depicting a fluid dispenser according to a second embodiment.

### DETAILED DESCRIPTION OF THE INVENTION

In the following detailed description, reference is made to the accompanying drawings, which form a part hereof. The illustrative embodiments described in the detailed description, drawings and claims are not meant to be limiting. Other embodiments can be utilized, and other changes can be made, without departing from the scope of the subject matter presented herein.

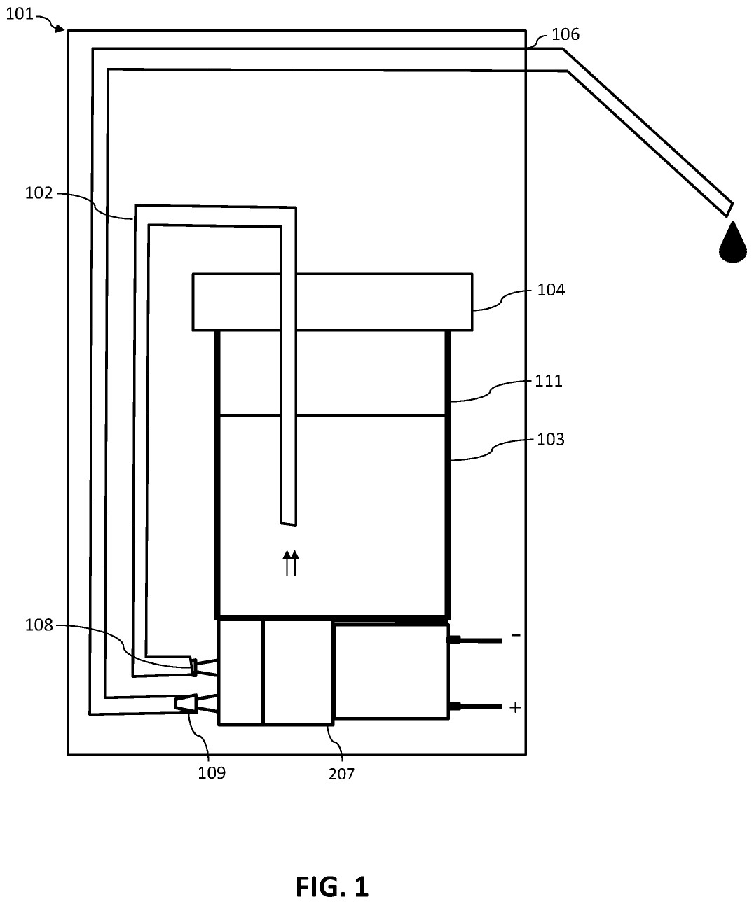

Referring to FIG. 1, a schematic representation of a fluid dispenser 101 as known in the art is depicted. The fluid dispenser 101 includes a container 111 that defines a reservoir 103 in which fluid is stored. The container 111 has a lid 104 which serves as an access point for replenishing the fluid. The reservoir 103 is in fluid communication with a pump 107 by way of fluid inlet 108. During operation, the pump 107 is energised and pulls fluid from the reservoir into the pump 107 and discharges the fluid through a water outlet 109 for dispensation via water conduit 106. Additionally, a valve (not depicted) such as an electromechanical valve, including a solenoid valve or electrically driven valve may be along the water conduit 106 for additional flow control.

This configuration has a number of drawbacks. Firstly, physical interaction between the internal components of the pump 107 and the fluid increases maintenance overhead since said internal components are relatively inaccessible. Secondly, the need for an on/off switch to be located on the fluid dispenser 101 to allow a user to control the dispensation of fluid by completing and breaking an electrical circuit that runs between an internal power source (not depicted) and the pump 107 means the device itself either requires additional engineering to ensure electrical components are kept waterproof which results in significantly higher manufacturing costs. On another hand, during cleaning, the pump 107 and electrical circuit can only have minimal direct interaction with water and cleaning fluids. In addition, the fluid dispenser 101 may require significant disassembly of internal components to effectively clean.

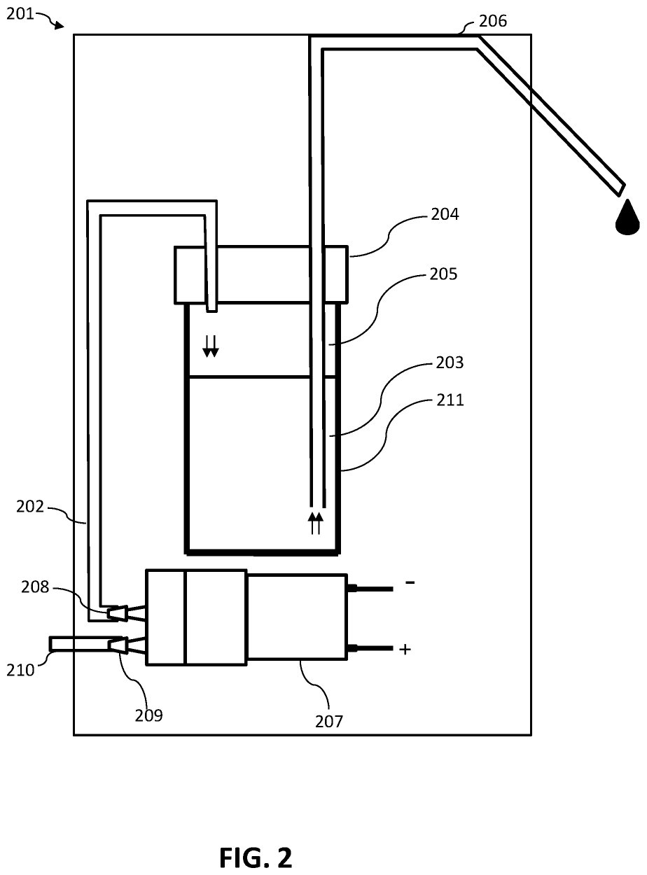

Referring to FIG. 2, a schematic representation of another fluid dispenser 201 as known in the art is depicted. The fluid dispenser 201 includes a container 211 that defines a reservoir 203 in which fluid is stored. The container 211 has a lid 204 which serves as an access point for replenishing the fluid. An air chamber 205 is located in the container 211 between the fluid stored in the container 211 and the lid 204 as air is supplied by an air delivery conduit 202. The lid 204 forms an air-tight seal such that air can only enter the air chamber 205 via the air delivery conduit 202. Pump 207 is connected to the air delivery conduit 202 thru an air outlet 208.

During operation, the pump 207 is energised and receives atmospheric air at an air inlet 209 via air supply port 210. Exterior atmospheric air entering pump 207 is delivered to the air chamber 205 by way of air delivery conduit 202. This leads to a rapid increase in pressure within air chamber 205 which in turn forces the fluid out of the reservoir thru a fluid outlet 206. Additionally, a valve (not depicted) such as an electromechanical valve including a solenoid valve or motorised valve may be located along fluid outlet 206 for additional flow control. Accordingly, the dispensing of fluid via the fluid outlet 206 is directly coupled to the delivery of air which in turn rapidly pressurises the air chamber 205. That is, dispensation starts almost immediately when the delivery of air into the air chamber 205 commences.

While doing away with the need for the fluid to physically interact with the pump, an on/off switch located on the fluid dispenser 201 itself to complete and break an electrical circuit that runs between an internal power source (not depicted) and the pump/valve which would once again require water-proofing just like in the case of the above fluid dispenser 101.

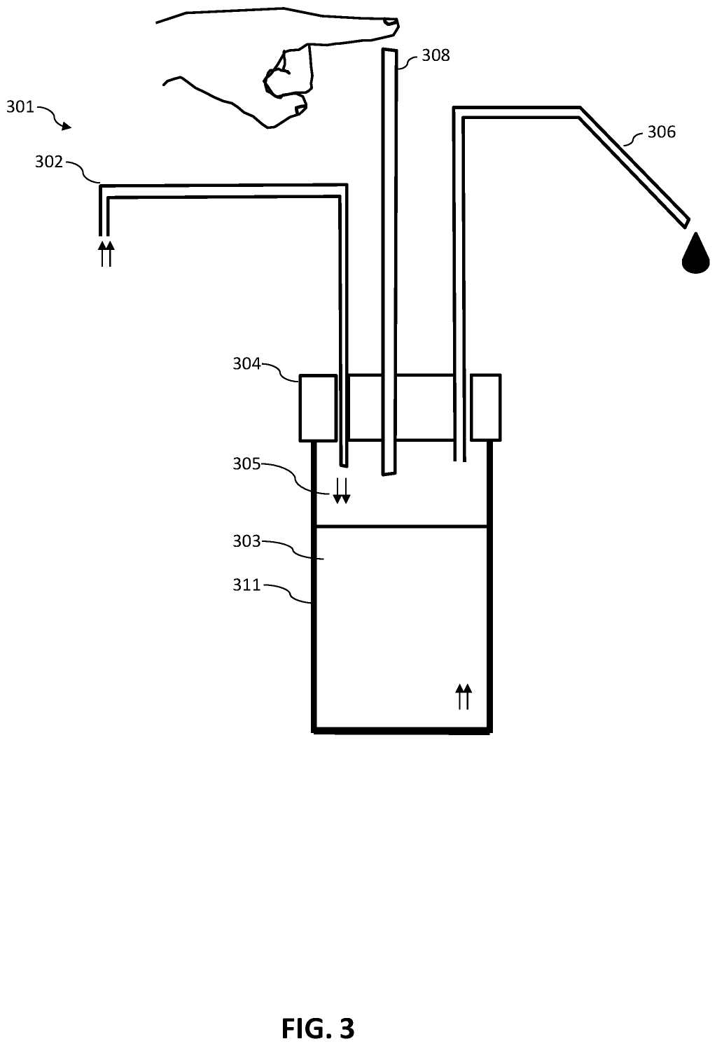

Referring to FIG. 3, a schematic representation of a handheld fluid dispenser 301 according to a preferred embodiment of the present invention is depicted. The portable dispenser 301 comprises a container 311 having a reservoir 303. The container 311 is enclosed by lid 304 which forms an air-tight seal with the container 311. For the purposes of irrigation, the reservoir 303 can typically be expected to be filled with water. However, it is envisaged that different fluids of varying viscosity including but not limited to more viscous fluids for example such as honey and cleaning fluids may be stored therein depending on the use case. The reservoir 303 can be replenished by disconnecting the container 311 from the lid 304. In the context of the present invention, the lid 304 can be any re-sealable access point that permits access to the reservoir 303 for the purposes of fluid replenishment. An air chamber 305 is formed in a space above the fluid and the lid receives air supplied by air delivery conduit 302. The air chamber 305 is normally in fluid communication with the exterior atmosphere by way of an air outlet 308. It will be readily understood by a skilled person that any conduit that permits fluid communication between the air chamber 305 and the exterior atmosphere may be employed.

During operation, and while in a first operation state, air is actively supplied into the air chamber 305 via the air delivery conduit 302. Air supplied in this manner is preferably done so as a constant stream but may also be supplied in pulses. In contrast with the above known fluid dispenser 201, the active supply of air to air chamber 305 does not at first instance lead to fluid dispensation due to the presence of the air outlet 308 which in its normally open state provides the delivered air from air delivery conduit 302 with a route to exit air chamber 305 and return to the exterior atmosphere thus preventing air pressure within the air chamber 305 from increasing.

When dispensing of the fluid from the reservoir 303 is desired, a second operation state is assumed, where the air outlet 308 is occluded while air is being actively delivered via air delivery conduit 302 into the air chamber 305. This second operation state can be attained as simply as by occluding the lumen of the air outlet 308 with a finger. This quickly leads to a build-up in air pressure within the air chamber 305 which in turn forces the fluid to discharge from the reservoir 305 via the fluid outlet 306. Dispensation of fluid can be easily halted by removing obstruction to the lumen of air outlet 308, for example, by lifting ones finger away. In this manner, the air outlet 308 serves as simple on/off switch or control valve that does not rely on an electrical circuit or an electrical component.

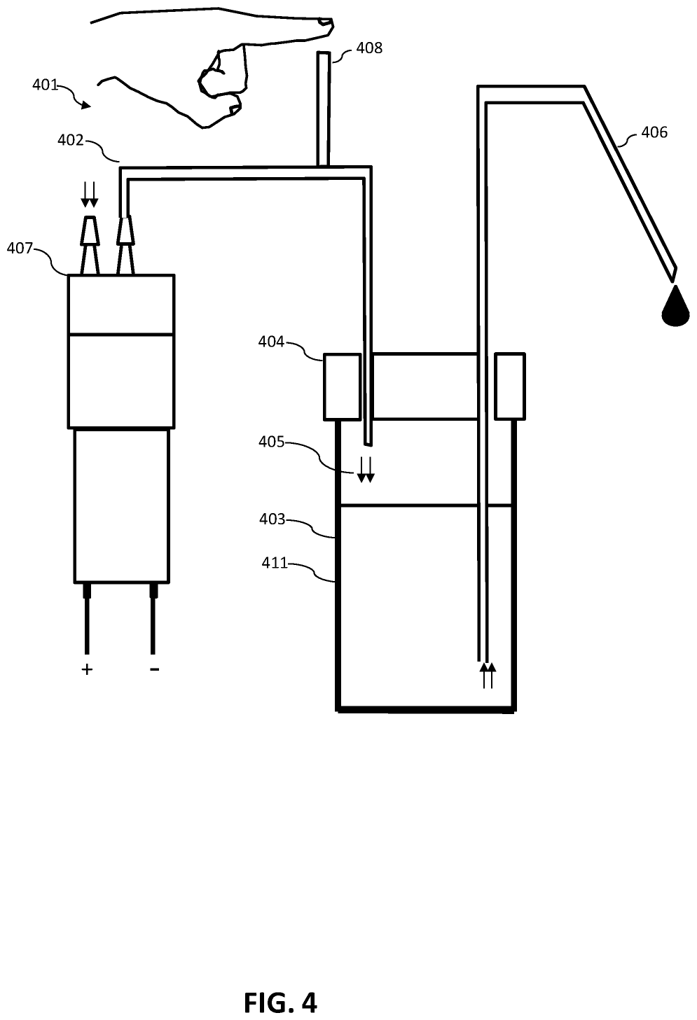

Referring to FIG. 4, a schematic representation of handheld fluid dispenser 401 according to a second embodiment of the present invention is depicted. An air outlet 408 is connected to an air delivery conduit 402 and accordingly shares a common passageway into air chamber 408. The air outlet 408 may be located anywhere along air delivery conduit 402. The on/off switch functionality provided by opening/occluding air outlet 408 remains operable. As in the above embodiment, air is delivered into air chamber 405 by an air pump 407 through the air delivery conduit 402. The air pump 407 is preferably selected from a group comprising a positive displacement pump, an air compressor and a blower. The positive displacement pump can be a gear pump, screw pump, rotary vane pump, plunger pump, piston pump, progressing cavity pump and peristaltic pump most preferably a diaphragm pump. A skilled person would readily understand that any device capable of moving air (compressed or otherwise) via air delivery conduit 402 can be employed in this manner. With air outlet 408 serving as an on/off switch, air pump 407 and its power supply (if applicable) can be located remotely from the device and away from the device proper as depicted in FIG. 4. For example, the air pump 407 can be attached to a user's belt or on any solid surface. This increases the portability and permits easy cleaning of the portable fluid dispenser 401 which can now be fully immersed in a cleaning fluid or in a dishwasher as there is no electrical safety concern since the air pump 407 can simply be disconnected from the air delivery conduit 402. In an alternative embodiment, the air pump 407 can be co-located with the portable fluid dispenser 401.

It will be appreciated by persons skilled in the art that various modifications can be made to the embodiments described above. For example, alternatively or in addition to the lid 304, 404, an access hatch (not depicted) defined by an exterior surface of the container 311, 411 that is in fluid communication with the reservoir 303, 403 can be employed to allow the reservoir 303, 403 to be refilled without the need for disconnection. In another example, the air outlet 308, 408 can be occluded by a mechanical valve, for example a throttle valve or a stopper. In another example, the air outlet 308, 408 can be made of a soft, flexible material that allows the air outlet 308, 408 to be occluded by a fastening device for example, a clamp.

1. A handheld device for dispensing a fluid comprising:
a container having a reservoir of the fluid, with the container having a lid and an air chamber located above the reservoir;
an air delivery conduit for supplying air into the air chamber;
a fluid discharge outlet having an end that is immersed in the fluid; and
an air outlet, wherein during a first state of operation, air entering the air chamber is simultaneously released through the air outlet.

2. The device according to claim 1, wherein during a second state of operation, pressure in the air chamber pushes the fluid out through the discharge outlet.

3. The device according to claim 1, wherein the air outlet is connected to the air delivery conduit.

4. The device according to claim 1, wherein the air outlet is defined by a surface of the lid.

5. The device according to claim 2, further comprising an air pump.

6. The device according to claim 5, wherein the air pump is located remotely from the device.

7. The device according to claim 5 or 6, wherein the air pump is selected from a group comprising a positive displacement pump, an air compressor and a blower.

8. The device according to claim 7, wherein the positive displacement pump is selected from a group comprising a gear pump, screw pump, rotary vane pump, plunger pump, piston pump, progressing cavity pump and peristaltic pump.

9. The device according to claim 7, wherein the positive displacement pump is a diaphragm pump.

10. The device according to claim 6, wherein the air pump is selected from a group comprising a positive displacement pump, an air compressor and a blower.

11. The device according to claim 10, wherein the positive displacement pump is selected from a group comprising a gear pump, screw pump, rotary vane pump, plunger pump, piston pump, progressing cavity pump and peristaltic pump.

12. The device according to claim 10, wherein the positive displacement pump is a diaphragm pump.
